(19) United States
(12) Patent Application Publication
(10) Pub. No.: US 2017/0288261 A1
(43) Pub. Date: Oct. 5, 2017

(54) ANODE COMPOSITE MATERIAL, METHOD FOR MAKING THE SAME, AND LITHIUM ION BATTERY

(71) Applicants: Jiangsu Huadong Institute of Li-Ion Battery Co., Ltd., Suzhou (CN); Tsinghua University, Beijing (CN)

(72) Inventors: Xiang-Ming He, Beijing (CN); Guan-Nan Qian, Suzhou (CN); Yu-Ming Shang, Beijing (CN); Jian-Jun Li, Beijing (CN); Li Wang, Beijing (CN); Ju-Ping Yang, Beijing (CN); Jian Gao, Beijing (CN); Peng Zhao, Beijing (CN); Yao-Wu Wang, Beijing (CN)

(73) Assignees: Jiangsu Huadong Institute of Li-Ion Battery Co., Ltd., Suzhou (CN); Tsinghua University, Beijing (CN)

(21) Appl. No.: 15/627,240

(22) Filed: Jun. 19, 2017

Related U.S. Application Data
(63) Continuation of application No. PCT/CN2015/096308, filed on Dec. 3, 2015.

(30) Foreign Application Priority Data
Dec. 19, 2014 (CN) 201410794924.3

(51) Int. Cl. H01M 10/0525; H01M 4/04; H01M 4/60; H01M 4/36; H01M 4/583

(52) U.S. Cl. CPC H01M 10/0525; H01M 4/362; H01M 4/583; H01M 4/602; H01M 4/0471; H01M 2004/027

(57) ABSTRACT

An anode composite material includes an anode active material and a polymer composited with the anode active material. The polymer is obtained by polymerizing a maleimide type monomer with an organic diamine type compound. The maleimide type monomer is a maleimide monomer, a bismaleimide monomer, a multimaleimide monomer, a maleimide type derivative monomer, or combinations thereof. A method for forming the anode composite material and a lithium ion battery are also disclosed.

### CROSS-REFERENCE TO RELATED APPLICATIONS

This application claims all benefits accruing under 35 U.S.C. §119 from China Patent Application No. 201410794924.3, filed on Dec. 19, 2014 in the State Intellectual Property Office of China, the content of which is hereby incorporated by reference. This application is a continuation under 35 U.S.C. §120 of international patent application PCT/CN2015/096308 filed on Dec. 3, 2015, the content of which is also hereby incorporated by reference.

### FIELD

The present disclosure relates to anode composite materials and method for making the same, and lithium ion batteries using the anode composite materials and methods for making the same.

### BACKGROUND

With the rapid development of portable electronic products, electric vehicles, and energy storage systems, there is an increasing need for lithium ion batteries due to their excellent performance and characteristics such as high energy density, long cyclic life, no memory effect, and light pollution when compared with conventional rechargeable batteries. Anode performance directly affects the capacity, the cycling performance, and safety of the lithium ion battery. Conventional anode materials are metal oxides, metal sulfides, and carbonaceous materials, such as graphite, acetylene black, carbon micro beads, petroleum coke, carbon fibers, cracked polymers, cracked carbon, etc. The carbonaceous materials are the most mature and widely used anode materials. The carbonaceous materials have good cycling performance and small volume change during lithium intercalation and deintercalation. Carbon atoms on surfaces of the carbonaceous materials have a large number of unsaturated bonds. Electrolytes are decomposed and form a solid electrolyte interface (SEI) film on the surfaces of the carbonaceous materials during the first charge of the battery.

### SUMMARY

One aspect of the present disclosure is to provide an anode composite material, a method for making the same, a lithium ion battery using the anode composite material, and a method for making the lithium ion battery.

An anode composite material comprises an anode active material and a polymer composited with the anode active material, wherein the polymer is obtained by polymerizing a maleimide type monomer with an organic diamine type compound. The maleimide type monomer is selected from the group consisting of a maleimide monomer, a bismaleimide monomer, a multimaleimide monomer, a maleimide type derivative monomer, and combinations thereof. The organic diamine type compound is represented by formula III or formula IV:

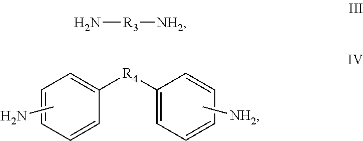

wherein R₃ is a bivalent organic substituent and R₄ is another bivalent organic substituent.

A lithium ion battery comprises a cathode, an anode, a separator, and an electrolyte solution. The anode comprises the above-mentioned anode composite material.

A method for making an anode composite material comprises: polymerizing a maleimide type monomer with an organic diamine type compound to form a polymer; and compositing the polymer with an anode active material. The polymerizing the maleimide type monomer with the organic diamine type compound comprises: dissolving the organic diamine type compound in an organic solvent to form a diamine solution; mixing the maleimide type monomer with an organic solvent, and then preheating to form a solution of the maleimide type monomer; and adding the diamine solution to the preheated solution of the maleimide type monomer, mixing and stirring to react adequately, and obtaining the polymer.

The present disclosure, the polymer is obtained by polymerizing the maleimide type monomer with the organic diamine type compound. The polymer is added to the anode material to increase a first cycling efficient of the anode, and improve a cycling stability of the lithium ion battery.

### BRIEF DESCRIPTION OF THE DRAWINGS

Implementations are described by way of example only with reference to the attached FIGURE.

The FIGURE is a graph showing a voltage-capacity differential curve of the lithium ion batteries in Example 3 and Comparative Example.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described.

One embodiment of an anode composite material comprises an anode active material and a polymer composited with the anode active material, wherein the polymer is obtained by polymerizing a maleimide type monomer with an organic diamine type compound. The polymer can be uniformly mixed with the anode active material or coated on a surface of the anode active material. A mass percentage of the polymer in the anode composite material can be in a range from about 0.01% to about 10%, such as from about 0.1% to about 5%.

The maleimide type monomer comprises at least one of a maleimide monomer, a bismaleimide monomer, a multimaleimide monomer, and a maleimide type derivative monomer.

The maleimide monomer can be represented by formula I:

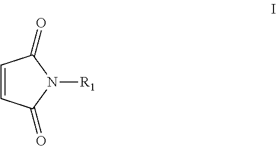

wherein R₁ is a monovalent organic substituent. More specifically, R₁ can be —R, —RNH₂R, —C(O)CH₃, —CH₂OCH₃, —CH₂S(O)CH₃, a monovalent alicyclic group, a monovalent substituted aromatic group, or a monovalent unsubstituted aromatic group, such as —C₆H₅, —C₆H₄C₆H₅, or —CH₂(C₆H₄)CH₃. R can be a hydrocarbyl with 1 to 6 carbon atoms, such as an alkyl with 1 to 6 carbon atoms. In the monovalent substituted aromatic group, an atom, such as hydrogen, can be substituted by a halogen, an alkyl with 1 to 6 carbon atoms, or a silane group with 1 to 6 carbon atoms to form the monovalent substituted aromatic group. The monovalent unsubstituted aromatic group can be phenyl, methyl phenyl, or dimethyl phenyl. A number of benzene rings in the monovalent substituted aromatic group or the monovalent unsubstituted aromatic group can be 1 to 2.

The maleimide monomer can be selected from N-phenyl-maleimide, N-(p-tolyl)-maleimide, N-(m-tolyl)-maleimide, N-(o-tolyl)-maleimide, N-cyclohexyl-maleimide, monomaleimide, maleimidephenol, maleimidebenzocyclobutene, dimethylphenyl-maleimide, N-methyl-maleimide, ethenyl-maleimide, thio-maleimide, ketone-maleimide, methylene-maleimide, maleimide-methyl-ether, maleimide-ethanediol, 4-maleimide-phenyl sulfone, and combinations thereof.

The bismaleimide monomer can be represented by formula II:

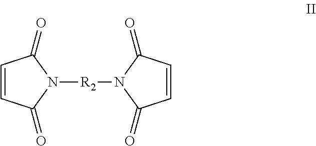

wherein R₂ is a bivalent organic substituent. More specifically, R₂ can be —R—, —RNH₂R—, —C(O)CH₂—, —CH₂OCH₂—, —C(O), —O—, —O—O—, —S—, —S—S—, —S(O)—, —CH₂S(O)CH₂—, —(O)S(O)—, —R—Si(CH₃)₂—O—Si(CH₃)₂—R—, a bivalent alicyclic group, a bivalent substituted aromatic group, or a bivalent unsubstituted aromatic group, such as phenylene (—C₆H₄—), diphenylene (—C₆H₄C₆H₄—), substituted phenylene, substituted diphenylene, —(C₆H₄)—R₅—(C₆H₄)—, —CH₂(C₆H₄)CH₂—, or —CH₂(C₆H₄)(O)—. R₅ can be —CH₂—, —C(O)—, —C(CH₃)₂, —O—, —O—O—, —S—, —S—S—, —S(O)—, or —(O)S(O)—. R₅ can be a hydrocarbyl with 1 to 6 carbon atoms, such as an alkyl with 1 to 6 carbon atoms. An atom, such as hydrogen, of the bivalent aromatic group can be substituted by a halogen, an alkyl with 1 to 6 carbon atoms, or a silane group with 1 to 6 carbon atoms to form the bivalent substituted aromatic group. A number of benzene rings in the bivalent substituted aromatic group or the bivalent unsubstituted aromatic group can be 1 to 2.

The bismaleimide monomer can be selected from N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-thiodimaleimide, N,N′-dithiodimaleimide, N,N′-ketonedimaleimide, N,N′-methylene-bismaleimide, bismaleimidomethyl-ether, 1,2-bismaleimido-1,2-ethandiol, N,N′-4,4′-diphenyl-ether-bismaleimide, 4,4′-bismaleimido-diphenylsulfone, and combinations thereof.

The maleimide type derivative monomer can be obtained by substituting a hydrogen atom of the maleimide monomer, the bismaleimide monomer, or the multimaleimide monomer with a halogen atom.

The organic diamine type compound can be represented by formula III or formula IV:

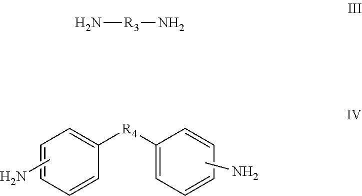

wherein R₃ is a bivalent organic substituent, and R₄ is another bivalent organic substituent.

R₃ can be —(CH₂)ₙ—, —CH₂—O—CH₂—, —CH(NH)—(CH₂)ₙ—, a bivalent alicyclic group, a bivalent substituted aromatic group, or a bivalent unsubstituted aromatic group, such as phenylene (—C₆H₄—), diphenylene (—C₆H₄C₆H₄—), substituted phenylene, or substituted diphenylene. R₄ can be —(CH₂)ₙ—, —O—, —S—, —S—S—, —CH₂—O—CH₂—, —CH(NH)—(CH₂)ₙ—, or —CH(CN)(CH₂)ₙ—. n can be 1 to 12. An atom, such as hydrogen, of the bivalent aromatic group can be substituted by a halogen, an alkyl with 1 to 6 carbon atoms, or a silane group with 1 to 6 carbon atoms to form the bivalent substituted aromatic group. A number of benzene rings in the bivalent substituted aromatic group or the bivalent unsubstituted aromatic group can be 1 to 2.

The organic diamine type compound can be selected from, but is not limited to, ethylenediamine, phenylenediamine, methylenedianiline, oxydianiline, and combinations thereof.

The molecular weight of the polymer can be in a range from about 1000 to about 500000.

In one embodiment, the maleimide type monomer is bismaleimide, the organic diamine type compound is methylenedianiline, and the polymer is represented by formula V:

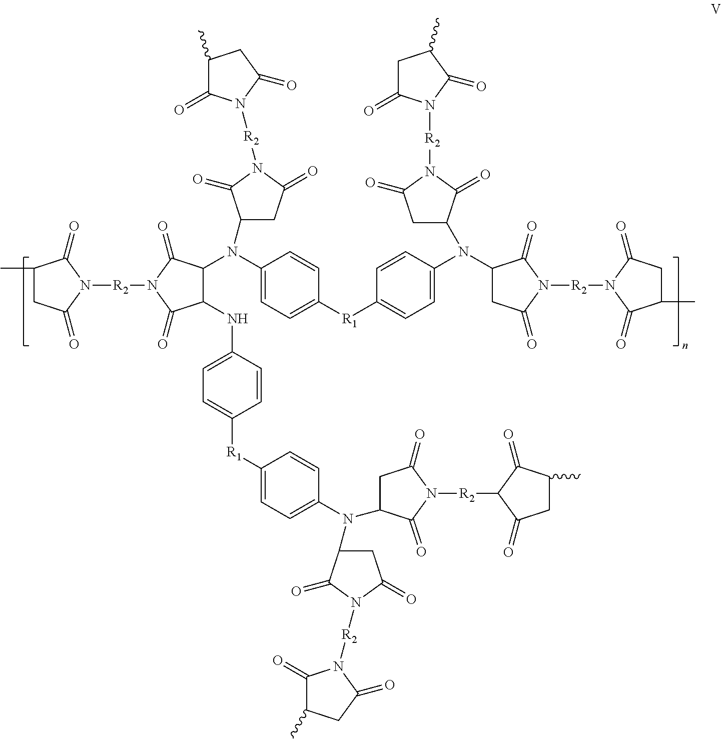

One embodiment of a method for making the anode composite material comprises polymerizing the maleimide type monomer with the organic diamine type compound and compositing with the anode active material.

The method for making the polymer comprises: dissolving the organic diamine type compound in an organic solvent to form a diamine solution; mixing the maleimide type monomer with an organic solvent, and then preheating to form a solution of the maleimide type monomer; and adding the diamine solution to the preheated solution of the maleimide type monomer, mixing and stirring to react adequately, and obtaining the polymer.

A molar ratio of the maleimide type monomer to the organic diamine type compound can be 1:10 to 10:1, such as 1:2 to 4:1. A mass ratio of the maleimide type monomer to the organic solvent in the solution of the maleimide type monomer can be 1:100 to 1:1, such as 1:10 to 1:2. The solution of the maleimide type monomer can be preheated to a temperature of about 30° C. to about 180° C., such as about 50° C. to about 150° C. A mass ratio of the organic diamine type compound to the organic solvent in the diamine solution can be 1:100 to 1:1, such as 1:10 to 1:2. The diamine solution can be transported into the solution of the maleimide type monomer at a set rate via a delivery pump, and then be stirred continuously for a set time to react adequately. The set time can be in a range from about 0.5 hours to about 48 hours, such as about 1 hour to about 24 hours. The solvent can be an organic solvent that dissolves the maleimide type monomer and the organic diamine type compound, such as gamma-butyrolactone, propylene carbonate, or N-methyl pyrrolidone (NMP).

In one embodiment, the maleimide type monomer and the organic diamine type compound are firstly polymerized into the polymer, and then the polymer is mixed with the anode active material or coated on the surface of the anode active material. In another embodiment, the solution of the maleimide type monomer and the anode active material are firstly mixed and preheated, and then added with the diamine solution, mixed, and stirred to react adequately to directly synthesize the polymer on the surface of the anode active material, thereby achieving a more complete coating.

The anode active material can be a carbonaceous material, such as at least one of graphite, mesophase carbon micro beads (MCMB), acetylene black, carbon micro beads, petroleum coke, carbon fibers, cracked polymers, carbon nanotubes, cracked carbon. The anode active material can also be lithium titanate or alloy anode materials.

The anode composite material can further comprise a conducting agent and/or a binder. The conducting agent can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene propylene diene monomer rubber, and styrene-butadiene rubber (SBR).

One embodiment of a lithium ion battery comprises a cathode electrode, an anode electrode, a separator, and an electrolyte liquid. The cathode electrode and the anode electrode are separated from each other by the separator. The cathode electrode can further comprise a cathode current collector and a cathode electrode material located on a surface of the cathode current collector. The anode can further comprise an anode current collector and the anode electrode material located on a surface of the anode current collector. The anode electrode material and the cathode electrode material are opposite to each other and spaced by the separator.

The cathode electrode material can comprise a cathode active material, and can further comprise a conducting agent and a binder. The cathode active material can be at least one of layer type lithium transition metal oxides, spinel type lithium transition metal oxides, and olivine type lithium transition metal oxides, such as olivine type lithium iron phosphate, layer type lithium cobalt oxide, layer type lithium manganese oxide, spinel type lithium manganese oxide, lithium nickel manganese oxide, and lithium cobalt nickel manganese oxide. The conducting agent in the cathode electrode material can be carbonaceous materials, such as at least one of carbon black, conducting polymers, acetylene black, carbon fibers, carbon nanotubes, and graphite. The binder can be at least one of polyvinylidene fluoride (PVDF), polyvinylidene fluoride, polytetrafluoroethylene (PTFE), fluoro rubber, ethylene propylene diene monomer rubber, and styrene-butadiene rubber (SBR).

In another embodiment, the cathode electrode material can further comprise the polymer. The cathode electrode can comprise the cathode current collector and a cathode composite material located on the surface of the cathode current collector. The polymer is obtained by polymerizing a maleimide type monomer with an organic diamine type compound. The polymer can be uniformly mixed with the cathode active material or coated on a surface of the cathode active material. The polymer composited with the cathode active material can be the same as the polymer composite with the anode active material. A mass percentage of the polymer in the cathode composite material can be in a range from about 0.01% to about 10%, such as from about 0.1% to about 5%.

The separator can be polyolefin microporous membrane, modified polypropylene fabric, polyethylene fabric, glass fiber fabric, superfine glass fiber paper, vinylon fabric, or composite membrane of nylon fabric, and wettable polyolefin microporous membrane composited by welding or bonding.

The electrolyte liquid comprises a lithium salt and a non-aqueous solvent. The non-aqueous solvent can comprise at least one of cyclic carbonates, chain carbonates, cyclic ethers, chain ethers, nitriles, amides and combinations thereof, such as ethylene carbonate (EC), diethyl carbonate (DEC), propylene carbonate (PC), dimethyl carbonate (DMC), ethyl methyl carbonate (EMC), butylene carbonate, gamma-butyrolactone, gamma-valerolactone, dipropyl carbonate, N-methyl pyrrolidone, N-methylformamide, N-methylacetamide, N,N-dimethylformamide, N,N-diethylformamide, diethyl ether, acetonitrile, propionitrile, anisole, succinonitrile, adiponitrile, glutaronitrile, dimethyl sulfoxide, dimethyl sulfite, vinylene carbonate, ethyl methyl carbonate, dimethyl carbonate, diethyl carbonate, fluoroethylene carbonate, chloropropylene carbonate, acetonitrile, succinonitrile, methoxymethylsulfone, tetrahydrofuran, 2-methyltetrahydrofuran, epoxy propane, methyl acetate, ethyl acetate, propyl acetate, methyl butyrate, ethyl propionate, methyl propionate, 1,3-dioxolane, 1,2-diethoxyethane, and 1,2-dimethoxyethane.

The lithium salt can comprise at least one of lithium chloride (LiCl), lithium hexafluorophosphate (LiPF₆), lithium tetrafluoroborate (LiBF₄), lithium methanesulfonate (LiCH₃SO₃), lithium trifluoromethanesulfonate (LiCF₃SO₃), lithium hexafluoroarsenate (LiAsF₆), lithium hexafluoroantimonate (LiSbF₆), lithium perchlorate (LiClO₄), Li[BF₂(C₂O₄)], Li[PF₂(C₂O₄)₂], Li[N(CF₃SO₂)₂], Li[C(CF₃SO₂)₃], and lithium bisoxalatoborate (LiBOB).

### Example 1

4 g of bismaleimide (BMI) and 2.207 g of methylenedianiline are separately dissolved in the γ-butyrolactone (solid content 10%) to form a bismaleimide solution and a methylenedianiline solution. The oxygen is removed from the solutions. The bismaleimide solution is heated to about 130° C. The methylenedianiline solution is added to the bismaleimide solution, and the mixed solution is kept at about 130° C. for about 24 hours to carry the polymerization. After being cooled, the product is precipitated in methanol, washed, and dried to obtain an oligomer.

### Example 2

4 g of bismaleimide (BMI) and 2.207 g of methylenedianiline are separately dissolved in the NMP (solid content 10%) to form a bismaleimide solution and a methylenedianiline solution. The oxygen is removed from the solutions. The bismaleimide solution is heated to about 80° C. The methylenedianiline solution is added to the bismaleimide solution, and the mixed solution is kept at about 80° C. for about 12 hours to carry the polymerization. After being cooled, the product is precipitated in methanol, washed, and dried to obtain an oligomer.

### Example 3

89.5% of graphite anode material, 0.5% of the oligomer in Example 1, 5% of the PVDF, and 5% of the conducting graphite by mass percent are mixed and dispersed by the NMP to form a slurry. The slurry is coated on an copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1 (v/v/v). A 2032 button battery is assembled, and a charge-discharge performance is tested.

### Example 4

89% of graphite anode material, 1% of the oligomer in Example 1, 5% of the PVDF, and 5% of the conducting graphite by mass percent are mixed and dispersed by the NMP to form a slurry. The slurry is coated on an copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1 (v/v/v). A 2032 button battery is assembled, and a charge-discharge performance is tested.

### Example 5

89.5% of graphite anode material, 0.5% of the oligomer in Example 2, 5% of the PVDF, and 5% of the conducting graphite by mass percent are mixed and dispersed by the NMP to form a slurry. The slurry is coated on an copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1 (v/v/v). A 2032 button battery is assembled, and a charge-discharge performance is tested.

### Comparative Example

90% of graphite anode material, 5% of the PVDF, and 5% of the conducting graphite by mass percent are mixed and dispersed by the NMP to form a slurry. The slurry is coated on an copper foil and vacuum dried at about 120° C. for about 12 hours to obtain the anode electrode. The counter electrode is lithium metal. The electrolyte liquid is 1 M of LiPF₆ dissolved in a solvent mixture of EC/DEC/EMC=1/1/1 (v/v/v). A 2032 button battery is assembled, and a charge-discharge performance is tested.

Electrochemical Performance Test

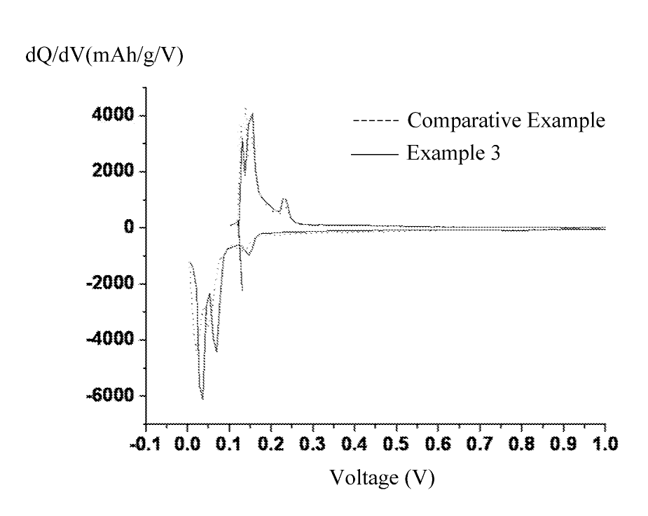

The lithium ion batteries of Examples 3, 4, 5 and Comparative Example are subjected to a cycling performance test. The test conditions are as follows: in the voltage range of 0.005V to 2V, the batteries are charged and discharged at a constant current rate (C-rate) of 0.1 C. The efficiency at first cycle and the discharge specific capacity of the 50^{th} cycle are shown in Table 1. It can be seen that Example 3 has the highest first cycle efficiency, and has a relatively high discharge capacity at the 50^{th} cycle showing the battery has a relatively good cycling stability and capacity retention. Referring to FIG. 1, the voltage-specific capacity curves in the first cycle of the batteries in Example 3 and Comparative Example are differentiated, to calculate the dQ/dV, which is the differential of battery capacity Q to battery voltage V. It can be seen from FIG. 1 that the battery in Example 3 has better capacity reversibility of the first cycle.

TABLE 1

| | Efficiency | Discharge specific |
|---|---|---|
| | at | capacity of the |
| | 1st cycle | 50^{th} cycle |
| | (%) | (mAh/g) |
| Example 3 | 89.3 | 324 |
| Example 4 | 86.8 | 316 |
| Example 5 | 87.1 | 317 |
| Comparative | 84.1 | 309 |
| Example 1 | | |

In the present disclosure, the polymer obtained by polymerizing the maleimide type monomer with the organic diamine type compound can be added into the anode material to improve the cycling efficiency at the first cycle and the cycling stability of the battery.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. An anode composite material comprising:
an anode active material; and
a polymer composited with the anode active material,
wherein the polymer is obtained by polymerizing a maleimide type monomer with an organic diamine type compound, the maleimide type monomer is selected from the group consisting of a maleimide monomer, a bismaleimide monomer, a multimaleimide monomer, a maleimide type derivative monomer, and combinations thereof; and the organic diamine type compound is represented by formula III or formula IV: 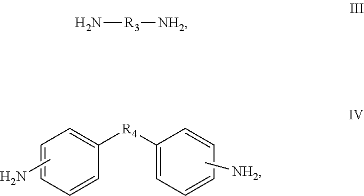
wherein R₃ is a bivalent organic substituent and R₄ is another bivalent organic substituent.

2. The anode composite material of claim 1, wherein R₃ is selected from the group consisting of —(CH₂)ₙ—, —CH₂—O—CH₂—, —CH(NH)—(CH₂)ₙ—, phenylene, diphenylene, substituted phenylene, substituted diphenylene, and bivalent alicyclic group, R₄ is selected from the group consisting of —(CH₂)ₙ—, —O—, —S—, —S—S—, —CH₂—O—CH₂—, —CH(NH)—(CH₂)ₙ—, and —CH(CN)(CH₂)ₙ—, and n=1 to 12.

3. The anode composite material of claim 1, wherein the organic diamine type compound is selected from the group consisting of ethylenediamine, phenylenediamine, methylenedianiline, oxydianiline, and combinations thereof.

4. The anode composite material of claim 1, wherein the maleimide monomer is represented by formula I: 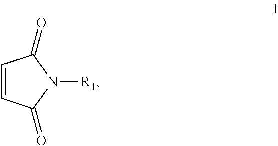
wherein R₁ is a monovalent organic substitute.

5. The anode composite material of claim 4, wherein R₁ is selected from the group consisting of —R, —RNH₂R, —C(O)CH₃, —CH₂OCH₃, —CH₂S(O)CH₃, —C₆H₅, —C₆H₄C₆H₅, —CH₂(C₆H₄)CH₃, and monovalent alicyclic group; R is hydrocarbyl with 1 to 6 carbon atoms.

6. The anode composite material of claim 1, wherein the maleimide monomer is selected from the group consisting of N-phenyl-maleimide, N-(p-tolyl)-maleimide, N-(m-tolyl)-maleimide, N-(o-tolyl)-maleimide, N-cyclohexyl-maleimide, maleimide, maleimidephenol, maleimidebenzocyclobutene, dimethylphenyl-maleimide, N-methyl-maleimide, ethenyl-maleimide, thio-maleimide, ketone-maleimide, methylene-maleimide, maleimide-methyl-ether, maleimide-ethanediol, 4-maleimide-phenyl sulfone, and combinations thereof.

7. The anode composite material of claim 1, wherein the bismaleimide monomer is represented by formula II: 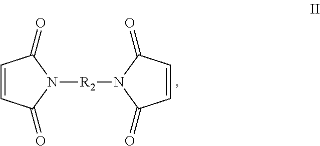
wherein R₂ is a bivalent organic substitute.

8. The anode composite material of claim 7, wherein R₂ is selected from the group consisting of —R—, —RNH₂R—, —C(O)CH₂—, —CH₂OCH₂—, —C(O), —O—, —O—O—, —S—, —S—S—, —S(O)—, —CH₂S(O)CH₂—, —(O)S(O)—, —CH₂(C₆H₄)CH₂—, —CH₂(C₆H₄)(O)—, —R—Si(CH₃)₂—O—Si(CH₃)₂—R—, —C₆H₄—, —C₆H₄C₆H₄—, bivalent alicyclic group or —(C₆H₄)—R₅—(C₆H₄)—; R₅ is —CH₂—, —C(O)—, —C(CH₃)₂, —O—, —O—O—, —S—, —S—S—, —S(O)—, and —(O)S(O)—; and R is hydrocarbyl with 1 to 6 carbon atoms.

9. The anode composite material of claim 1, wherein the bismaleimide monomer is selected from the group consisting of N,N′-bismaleimide-4,4′-diphenyl-methane, 1,1′-(methylene-di-4,1-phenylene)-bismaleimide, N,N′-(1,1′-diphenyl-4,4′-dimethylene)-bismaleimide, N,N′-(4-methyl-1,3-phenylene)-bismaleimide, 1,1′-(3,3′-dimethyl-1,1′-diphenyl-4,4′-dimethylene)-bismaleimide, N,N′-ethenyl-bismaleimide, N,N′-butenyl-bismaleimide, N,N′-(1,2-phenylene)-bismaleimide, N,N′-(1,3-phenylene)-bismaleimide, N,N′-thiodimaleimide, N,N′-dithiodimaleimide, N,N′-ketonedimaleimide, N,N′-methylene-bismaleimide, bismaleimidomethyl-ether, 1,2-bismaleimido-1,2-ethandiol, N,N′-4,4′-diphenyl-ether-bismaleimide, 4,4′-bismaleimido-diphenylsulfone, and combinations thereof.

10. The anode composite material of claim 1, wherein a molecular weight of the polymer is in a range from about 1000 to about 500000.

11. The anode composite material of claim 1, wherein a molar ratio of the maleimide type monomer to the organic diamine type compound is 1:10 to 10:1.

12. The anode composite material of claim 1, wherein a molar ratio of the maleimide type monomer to the organic diamine type compound is 1:2 to 4:1.

13. The anode composite material of claim 1, wherein a mass percent of the polymer in the anode composite material is in a range from about 0.1% to about 5%.

14. The anode composite material of claim 1, wherein the anode active material is selected from the group consisting of graphite, mesophase carbon micro beads, acetylene black, petroleum coke, carbon fibers, cracked polymers, carbon nanotubes, cracked carbon, and combinations thereof.

15. A lithium ion battery comprising a cathode electrode, an anode electrode, a separator, and an electrolyte liquid, the cathode electrode comprises an anode composite material comprising:
an anode active material; and
a polymer composited with the anode active material,
wherein the polymer is obtained by polymerizing a maleimide type monomer with an organic diamine type compound, the maleimide type monomer is selected from the group consisting of a maleimide monomer, a bismaleimide monomer, a multimaleimide monomer, a maleimide type derivative monomer, and combinations thereof; and the organic diamine type compound is represented by formula III or formula IV: 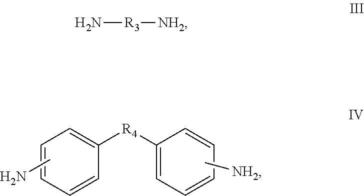
wherein R₃ is a bivalent organic substituent and R₄ is another bivalent organic substituent.

16. A method for making an anode composite material comprising:
polymerizing a maleimide type monomer with an organic diamine type compound to form a polymer; and
compositing the polymer with an anode active material;
wherein the maleimide type monomer is selected from the group consisting of a maleimide monomer, a bismaleimide monomer, a multimaleimide monomer, a maleimide type derivative monomer, and combinations thereof; and the organic diamine type compound is represented by formula III or formula IV: 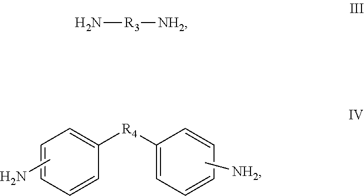
wherein R₃ is a bivalent organic substituent and R₄ is another bivalent organic substituent.

17. The method of claim 16, wherein a molar ratio of the maleimide type monomer to the organic diamine type compound is 1:2 to 4:1.

18. The method of claim 16, further comprising:
dissolving the organic diamine type compound in an organic solvent to form a diamine solution;
mixing the maleimide type monomer with another organic solvent to form a first mixture, and then preheating the first mixture to form a solution of the maleimide type monomer;
further mixing the anode active material with the solution of the maleimide type monomer to form a second mixture;
adding the diamine solution to the second mixture to directly synthesize the polymer on a surface of the anode active material.
